(19) United States
(12) Patent Application Publication
(10) Pub. No.: US 2016/0153285 A1
(43) Pub. Date: Jun. 2, 2016

(54) TURBINE BLADE

(71) Applicant: SIEMENS AKTIENGESELLSCHAFT, München (DE)

(72) Inventors: Fathi Ahmad, Kaarst (DE); Andreas Heselhaus, Dusseldorf (DE)

(73) Assignee: Siemens Aktiengesellschaft, Munich (DE)

(21) Appl. No.: 14/906,048

(22) PCT Filed: Jul. 16, 2014
(86) PCT No.: PCT/EP2014/065205

§ 371 Date: Jan. 19, 2016

(30) Foreign Application Priority Data
Jul. 29, 2013 (EP) 13178390.4

(51) Int. Cl. F01D 5/18; F01D 5/02; F01D 25/12; F01D 5/14; F01D 9/04

(52) U.S. Cl. CPC F01D 5/187; F01D 5/147; F01D 9/041; F01D 25/12; F01D 5/02; F05D 2220/32; F05D 2240/30; F05D 2240/12; F05D 2260/202

(57) ABSTRACT

A turbine blade includes a first cooling air duct and a second cooling air duct which is separated from the first cooling air duct by a wall and which has a main direction, wherein the first and the second cooling-air duct are connected to one another by a first opening in the wall, wherein the wall has a second opening, to permit an improved cooling air action and thus higher operating temperatures and higher efficiency of the turbine. The second opening is adjoined by a diverting duct, the main direction of which, in the region in which the diverting duct issues into the second cooling air duct, is oriented substantially parallel to the main direction of the second cooling air duct.

### CROSS REFERENCE TO RELATED APPLICATIONS

This application is the US National Stage of International Application No. PCT/EP2014/065205 filed Jul. 16, 2014, and claims the benefit thereof. The International Application claims the benefit of European Application No. EP13178390 filed Jul. 29, 2013. All of the applications are incorporated by reference herein in their entirety.

### FIELD OF INVENTION

The invention relates to a turbine blade with a first cooling air duct and a second cooling air duct, which is separated from the first cooling air duct by a wall, is neighboring the first cooling air duct and has a main direction, wherein the first and second cooling air ducts are connected to one another at their respective end by a first opening in the wall, wherein the wall has a second opening, which separates the wall in a middle region into a first part and a second part.

### BACKGROUND OF INVENTION

A turbine is a flow machine, which converts the internal energy (enthalpy) of a flowing fluid (liquid or gas) into rotational energy and ultimately into mechanical drive energy. The laminar flow around the turbine blades, which is as free from turbulence as possible, has the effect of extracting from the stream of fluid some of its internal energy, which passes on to the moving blades of the turbine. These then set the turbine shaft in rotation, and the usable power is delivered to a machine coupled thereto, such as for example a generator. The moving blades and the shaft are parts of the movable rotor of the turbine, which is arranged within a housing.

Generally a number of blades are mounted on the shaft. Moving blades mounted in a plane respectively form an impeller or rotor. The blades are profiled in a slightly curved manner, similar to an aircraft wing. Upstream of each rotor there is usually a stator. These stationary blades protrude from the housing into the flowing medium and impart a spin to it. The spin generated in the stator (kinetic energy) is used in the subsequent rotor to set the shaft on which the rotor blades are mounted in rotation. The rotor and the stator are together referred to as a stage. Often a number of such stages are connected one behind the other.

The turbine blades of a turbine are subjected to particular loads. The high loads necessitate materials that are highly load-resistant. Turbine blades are therefore produced from titanium alloys, nickel superalloy or tungsten-molybdenum alloys. The blades are protected by coatings for greater resistance to temperatures and erosion, such as for example pitting, also known as “pitting corrosion”. The heat shielding coating is known as a thermal barrier coating or TBC for short. Further measures for making the blades more heat-resistant comprise ingenious systems of cooling ducts. This technique is used both in the stationary blades and in the moving blades.

The turbine blades often have cast-in cooling ducts that wend their way through the respective turbine blades in a serpentine or meandering manner, i.e. the wall between two cooling ducts is interrupted at its respective end by an opening through which the cooling air is diverted into the second duct in the opposite direction, i.e. the main direction of the cooling air of the second duct. Such cooling ducts are known for example from EP 1 607 576 A2. It is sometimes necessary here to provide additional openings, known as “cooling air refreshers”, in the wall between the two serpentine passages, which as a partial bypass feed fresher air, i.e. cooler air, into a middle region of the second cooling air duct, in order still to achieve a sufficient cooling effect here. This may however also be necessary for reasons of stability of the cast core.

The thermal loading of the turbine blades currently restricts the efficiency of the turbine, since the materials only allow a limited operating temperature. High operating temperatures however have a positive effect on the Carnot efficiency.

### SUMMARY OF INVENTION

An object of the invention is therefore to provide a turbine blade of the type mentioned at the beginning that allows an improved cooling air effect, and consequently higher operating temperatures and a higher efficiency of the turbine.

This object is achieved according to the invention by the second opening being adjoined by a diverting duct, the main direction of which in the region in which it enters the second cooling air duct is aligned substantially parallel to the main direction of the second cooling air duct.

The invention is based here on the idea that the aerodynamic bypass between two cooling air ducts that is formed by the cooling air refreshers can sensitively disturb the cooling air stream, and consequently may lead to problems in the cooling of the turbine blade. It has surprisingly been found that, on account of the in some cases great differences in pressure between neighboring cooling ducts, the cooling air can leave the cooling air refresher at up to 0.8 Ma. This means that the momentum of the cooling air from the cooling air refresher is much greater than the momentum of the other cooling air flowing along the main direction in the cooling air duct. The stream consequently does not go over into the main direction, but impinges on the opposite wall almost unchecked, and is only limitedly available downstream of the cooling air refresher. In order to counteract this, a mechanical diversion of the cooling air stream from the cooling air refresher into the main direction of the second duct should be provided. This can be achieved by the opening of the cooling air refresher being adjoined by a diverting duct that aligns the cooling air parallel to the main direction of the second duct.

In an advantageous configuration, the second cooling air duct is delimited by an outer wall of the turbine blade that has a plurality of cooling air outlet openings. This is so because, in particular in the case of cooling air ducts that are directly adjacent the outer wall of the blade and have outlet openings for film cooling, such as for example at the profile tip, there is the problem that the cooling air emerging at great momentum from the cooling air refresher impinges directly on the opposite outlet openings and flows out there. Consequently, scarcely any fresh cooling air is available downstream of the cooling air refresher. Therefore, the described diversion is particularly advantageous here.

In a further advantageous configuration, a delimitation of the cooling air duct is formed by a part of the wall adjoining the second opening. In other words: the diverting duct runs parallel to the wall, so that the wall forms a delimitation between the first cooling air duct and the diverting duct. This makes particularly easy shaping possible during the casting process, since the corresponding wall can be configured as straight throughout.

In yet a further advantageous configuration, a delimitation of the cooling air duct is formed by parallel parts of the wall that are offset with respect to one another. The two parts of the wall, on the near side and the far side of the opening, are therefore extended beyond the opening in a parallel-offset manner, and consequently partially overlap. As a result, the diverting duct may be formed by simple extension of the parts of the wall, without additional walls.

In a first advantageous configuration of the turbine blade, the offset of the wall is in this case brought back outside the region of the cooling air duct in such a way that the wall runs in a straight line outside the region of the cooling air duct. In other words: the wall runs along a straight line, wherein part of the wall on one side of the opening is deflected and taken parallel to the other part of the wall on the other side of the wall. This part therefore describes an S shape in the region of the opening, whereby the diverting duct is formed.

In a second, alternative advantageous configuration, the parts of the wall differing by the second opening and lying outside the region of the cooling air duct run on parallel straight lines that are at a distance from one another. This means that the two parts of the wall, on the near side and the far side of the opening, run parallel to one another, but do not lie on one straight line. They respectively form a straight line, wherein the two straight lines overlap in the region of the cooling air refresher and thus form the diverting duct for the cooling air.

In this case, the length of the cooling air duct is advantageously greater than its width. The length is in this case taken to be the distance along which the two parts of the wall run parallel to one another, while the width is formed by the distance between the two parts of the wall. This ensures that a sufficient diversion of the momentum of the cooling air takes place and the component of the momentum that extends perpendicularly to the main direction is largely eliminated.

A stator or rotor for a turbine advantageously comprises such a turbine blade as a stationary or moving blade.

A turbine advantageously comprises such a stator and/or rotor.

The turbine is in this case advantageously designed as a gas turbine. Specifically in gas turbines, the thermal and mechanical loads are particularly high, so that the described configuration of the turbine blade offers particular advantages with regard to the cooling, and consequently also the efficiency.

A power generating plant advantageously comprises such a turbine.

The advantages achieved by the invention are in particular that a more uniform cooling is achieved, in particular at the profile tip of a turbine blade, by the specific diversion of the cooling air in a cooling air refresher into the direction of flow of the intended cooling duct. There is no crossing of the cooling air stream, as a result of which the number of cooling air refreshers can also be increased, which in turn increases the stability of the cast core, and consequently brings advantages in the production of the turbine blade. Improved conduction of the cooling air has the effect that the cooling effect is improved and at the same time the consumption of cooling air is reduced. This increases the efficiency of the turbine.

### BRIEF DESCRIPTION OF THE DRAWINGS

Exemplary embodiments of the invention are explained in more detail on the basis of a drawing, in which:

FIG. 1 shows a partial longitudinal section through a gas turbine,

FIG. 2 shows the profile of a moving blade,

FIG. 3 shows a longitudinal section through the moving blade,

FIG. 4 shows a cooling air refresher in a first embodiment, and

FIG. 5 shows a cooling air refresher in a second embodiment.

### DETAILED DESCRIPTION OF INVENTION

The same parts are provided with the same designations in all of the figures.

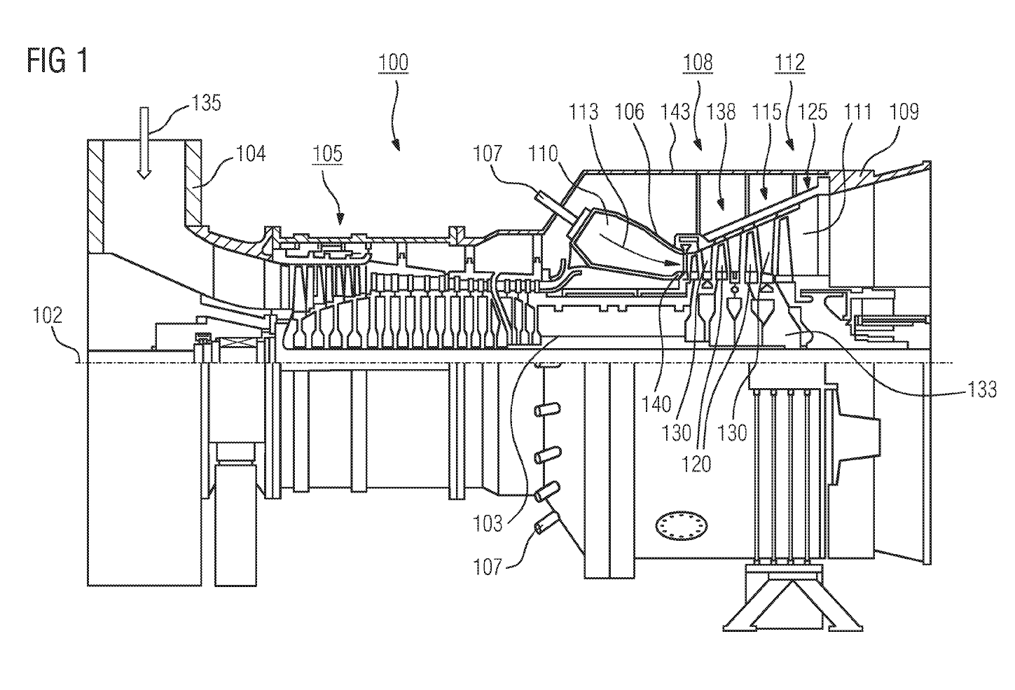

FIG. 1 shows a turbine 100, here a gas turbine, in a longitudinal partial section. The gas turbine 100 has inside a rotor 103, which is rotatably mounted about an axis of rotation 102 (axial direction) and is also referred to as a turbine rotor. Following one another along the rotor 103 are an intake housing 104, a compressor 105, a toroidal combustion chamber 110, in particular an annular combustion chamber 106, with a number of coaxially arranged burners 107, a turbine 108 and the exhaust housing 109.

The annular combustion chamber 106 communicates with an annular hot gas duct 111. There, for example four series-connected turbine stages 112 form the turbine 108. Each turbine stage 112 is formed from two blade rings. As seen in the direction of flow of a working medium 113, in the hot gas duct 111 a row of stationary blades 115 is followed by a row 125 formed from moving blades 120.

The stationary blades 130 are in this case secured to the stator 143, whereas the moving blades 120 of a row 125 are fitted to the rotor 103 by means of a turbine disk 133. The moving blades 120 consequently form component parts of the rotor 103. Coupled to the rotor 103 is a generator or a machine (not represented).

While the gas turbine 100 is operating, the compressor 105 sucks in air 135 through the intake housing 104 and compresses it. The compressed air provided at the turbine-side end of the compressor 105 is passed to the burners 107 and is mixed there with a fuel. The mix is then burnt in the combustion chamber 110, forming the working medium 113. From there, the working medium 113 flows along the hot gas duct 111 past the stationary blades 130 and the moving blades 120. The working medium 113 expands at the moving blades 120, imparting its momentum, so that the moving blades 120 drive the rotor 103 and the latter drives the machine coupled to it.

While the gas turbine 100 is operating, the components which are exposed to the hot working medium 113 are subjected to thermal stresses. The stationary blades 130 and moving blades 120 of the first turbine stage 112, as seen in the direction of flow of the working medium 113, together with the heat shield elements which line the annular combustion chamber 106, are subjected to the highest thermal stresses. To be able to withstand the temperatures which prevail there, they are cooled by means of a coolant. Similarly, the blades 120, 130 may have coatings against corrosion (MCrAlX; M=Fe, Co, Ni, rare earths) and heat (thermal barrier coating, for example ZrO₂, Y₂O₄—ZrO₂).

Each stationary blade 130 has a stationary blade root (not represented here), facing the housing 138 of the turbine 108, and a stationary blade head, at the opposite end from the stationary blade root. The stationary blade head faces the rotor 103 and is fixed to a sealing ring 140 of the stator 143. Each sealing ring 140 thereby encloses the shaft of the rotor 103.

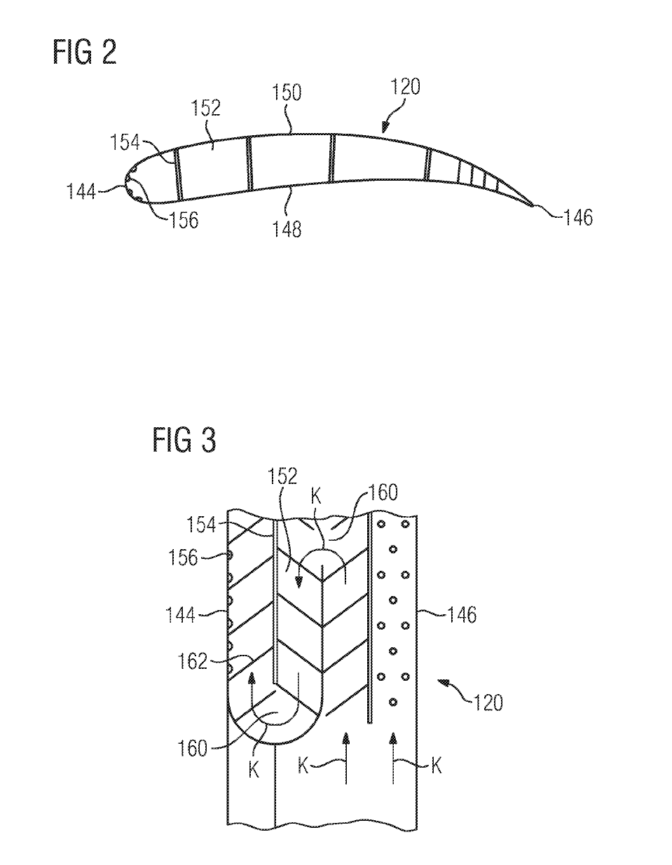

In FIG. 2, the profile of a moving blade 120 is shown by way of example. The profile resembles that of an aircraft wing. It has a rounded profile tip 144 and a trailing profile edge 146. Between the profile tip 144 and the trailing profile edge 146 there extend the pressure side 148 and the suction side 150 of the moving blade. Incorporated between the pressure side 148 and the suction side 150 are cooling air ducts 152, which extend along the main direction of extent of the moving blade 120, leading into FIG. 2, and are delimited from one another by walls 154.

Provided here in the region of the profile tip 144 are cooling air outlet openings 156, through which cooling air can emerge, and thus form a protective cooling film on the outer side of the moving blade 120. Additionally arranged in the cooling air duct 152 adjacent the trailing profile edge 146 are pin-like cooling bodies 158, known as “pin fins”, which improve the heat transfer from the cooling air into the moving blade 120 by their surface located in the cross section of the cooling air.

FIG. 3 shows the moving blade 120 in longitudinal section. It can be seen here that the three parallel cooling ducts 152 adjoining the profile tip 144 are connected via openings 160 at their respective ends in such a way that they form a meandering common duct. Cooling air K enters at the lower end of FIG. 3 and at the end of the duct is respectively diverted into the opposite direction at each opening 160, and continues to flow in this way along the duct until it finally emerges at the cooling air outlet openings 156.

In the said three cooling air ducts 152, arranged on the flat outer side of the moving blade 120 are cooling ribs 162, which act as turbolators and thus improve the cooling effect. By contrast, the cooling air duct 152 facing the trailing profile edge 146 is connected separately and, as described, has cooling bodies 158. It can be seen in FIG. 3 that the cooling bodies 158 form a grid.

The cooling structure described has been explained on the basis of the example of a moving blade 120. Similar cooling structures may also be provided correspondingly in stationary blades 130. The configuration described below of a wall 154 between two cooling air ducts 154 may be similarly realized there.

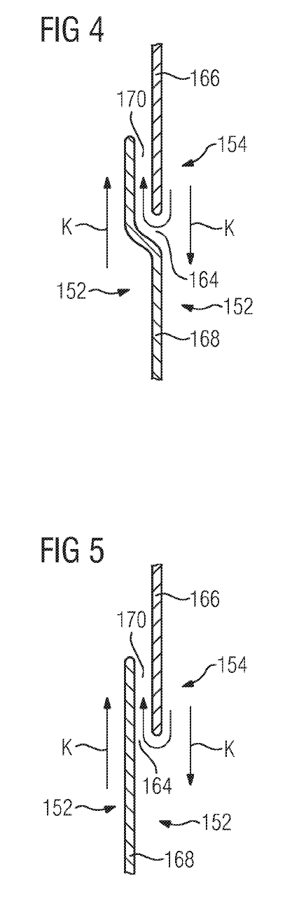

FIG. 4 and FIG. 5 respectively show the wall 154 between the cooling duct 152 adjacent the profile tip 144 and the cooling duct 152 neighboring it. On account of the emergence of the cooling air K through the cooling air outlet openings 156, it is required here to provide what are known as cooling air refreshers at various points in the middle region of the wall 152, i.e. away from the end of the cooling ducts 152. These cooling air refreshers substantially comprise an opening 164 in the middle region in the wall 152, so that the latter is divided into a first part 166 and a second part 168.

As a result of the considerable difference in pressure between the cooling air ducts 152, cooling air K emerges at great momentum through the opening 164 into the cooling air duct 152 adjacent the profile tip 144. By analogy with FIG. 3, its main direction of flow of the cooling air K points upward in FIGS. 4 and 5. In order that this cooling air K does not flow directly perpendicularly to the main direction into the cooling outlet openings 156 opposite the opening 164, in the exemplary embodiments of FIGS. 4 and 5 there respectively adjoins a diverting duct 170, which is aligned parallel to the main direction. The cooling air K in the diverting duct 170 consequently flows parallel to the cooling air K in the cooling air duct 152 adjacent the profile tip 144.

In the exemplary embodiment of FIG. 4, this is realized by the second part 168 of the wall 154 being offset in an S-shaped manner in the region of the opening 164 and running with an offset parallel to the first part 166. Outside the region of the diverting duct 170, the two parts 166, 168 run on one line.

In the exemplary embodiment of FIG. 5, the two parts 166, 168 do not run on one line, but are offset parallel to one another. Only by a straight overlap do they form the diverting duct 170.

In both exemplary embodiments, the length of the diverting duct 170 is greater than its width, so that a reliable diversion of the cooling air K is ensured.

1. A turbine blade comprising:
a first cooling air duct and
a second cooling air duct, which is separated from the first cooling air duct by a wall, is neighboring the first cooling air duct and has a main direction,
wherein the first and second cooling air ducts are connected to one another at their respective end by a first opening in the wall,
wherein the wall has a second opening, which separates the wall in a middle region into a first part and a second part,
wherein the second opening is adjoined by a diverting duct, the main direction of which in the region in which it enters the second cooling air duct is aligned substantially parallel to the main direction of the second cooling air duct.

2. The turbine blade as claimed in claim 1,
wherein the second cooling air duct is delimited by an outer wall of the turbine blade that has a plurality of cooling air outlet openings.

3. The turbine blade as claimed in claim 1,
wherein a delimitation of the cooling air duct is formed by a part of the wall adjoining the second opening.

4. The turbine blade as claimed in claim 1,
wherein a delimitation of the cooling air duct is formed by parallel parts of the wall that are offset with respect to one another.

5. The turbine blade as claimed in claim 4,
wherein the offset of the wall is brought back outside the region of the cooling air duct in such that the wall runs in a straight line outside the region of the cooling air duct.

6. The turbine blade as claimed in claim 4,
wherein the parts of the wall differing by the second opening and lying outside the region of the cooling air duct run on parallel straight lines that are at a distance from one another.

7. The turbine blade as claimed in claim 4,
wherein the length of the cooling air duct is greater than its width.

8. A stator or rotor comprising:
a turbine blade as claimed in claim 1.

9. A turbine comprising:
a stator and/or rotor as claimed in claim 8.

10. The turbine as claimed in claim 8,
which comprises a gas turbine.

11. A power generating plant comprising:
a turbine as claimed in claim 9.
